(19) United States
(12) Patent Application Publication
(10) Pub. No.: US 2021/0386240 A1
(43) Pub. Date: Dec. 16, 2021

(54) FLEXIBLE UTENSIL WITH METAL REINFORCED HANDLES

(71) Applicant: Rashida Masalawala, San Diego, CA (US)

(72) Inventor: Rashida Masalawala, San Diego, CA (US)

(21) Appl. No.: 16/897,527

(22) Filed: Jun. 10, 2020

(51) Int. Cl. A47J 37/01; A21B 3/13

(52) U.S. Cl. CPC A47J 37/01; A21B 3/138

(57) ABSTRACT

A utensil such as a pan is provided. The utensil has metal reinforced handles covered with silicone material and a body made of silicone material.

### CROSS-REFERENCE TO RELATED APPLICATIONS

Not Applicable,

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates generally to a utensil. More so, the present disclosure relates to a flexible utensil with metal reinforced handles.

### Description of the Related Art

Utensils such as muffin or cupcake pan, brownie or cake pans such as square pan or round pan or rectangular pan, loaf or bread pan, pie or tart pan, donut pan, chocolate or candy molds and so on are commonly used for baking. Typically such utensils are made of metal. However, it is difficult to release food such as muffins, cakes and chocolates from such metal pans and molds. In addition, metal pans and molds are heavy. In some cases, people use flexible pans, which require the use of metal plates under the pans to be able to carry them from one place to another.

In the light of above shortcoming, there is a need of a utensil that provides ease of carrying with handles, ease of food release while providing stability comparable to metal utensil and ergonomically handling using handles.

### BRIEF SUMMARY OF THE INVENTION

A primary object of the disclosure is to provide a flexible utensil with metal reinforced handles.

Another object of the present disclosure is a flexible utensil where a user can push the bottom to release food item.

Yet another object of the present disclosure is to provide a flexible utensil that has handles maintain the stability of the utensil.

Another object of the present disclosure is to provide a flexible utensil that can be used in a microwave along with a freezer and an oven.

### DESCRIPTION OF THE DRAWINGS

Having thus described the disclosure in general terms, reference will now be made to the accompanying figures, wherein:

FIG. 1 illustrates a utensil, in accordance with an embodiment of the present disclosure,

FIG. 2 illustrates a utensil, in accordance with another embodiment of the present disclosure,

FIG. 3 illustrates a utensil, in accordance with yet another embodiment of the present disclosure,

FIG. 4 illustrates a utensil, in accordance with another embodiment of the present disclosure, and

FIG. 5 illustrates a utensil 500, in accordance with another embodiment of the present disclosure.

It should be noted that the accompanying figures are intended to present illustrations of exemplary embodiments of the present disclosure. This figure is not intended to limit the scope of the present disclosure. It should also be noted that accompanying figures are not necessarily drawn to scale.

### DETAILED DESCRIPTION OF THE INVENTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

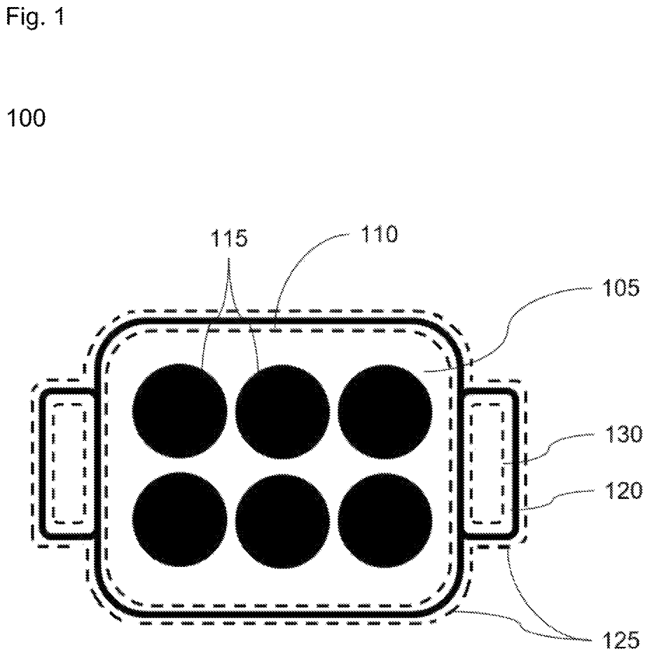

FIG. 1 illustrates a utensil 100, in accordance with an embodiment of the present disclosure. The utensil 100 has a utensil periphery 125. For example, the utensil can be a muffin pan, cupcake pan, a square pan, a round pan, a loaf pan, a pie pan, a chocolate mold, a soap mold, an ice mold, and so forth. The utensil 100 has a flexible utensil body 105 and a one or more utensil handles 120. For example, the handles can be of rectangular shape, semi-circular shape, and so forth. The flexible utensil body 105 has a body periphery 110. In an embodiment of the present disclosure, the flexible utensil body 105 has one or more cavities 115. In another embodiment of the present disclosure, the flexible utensil body 105 has no cavities. The flexible utensil body 105 is made of a flexible material such as silicone. It enables easy release of food from the flexible utensil body 105. For example, a user can push the bottom to release a muffin from the one or more cavities 115 of the utensil 100. It will be understood to a person ordinarily skilled in the art that the one or more cavities 115 can be of any shape and size such as donut shaped, heart shaped, egg shaped, and so forth without limiting the scope of the disclosure. The one or more utensil handles 120 of the utensil 100 are attached to the flexible utensil body 105. The one or more utensil handles 120 are shown to have handle periphery 130. The one or more utensil handles 120 (the handle periphery 130) and the body periphery 110 together forms the utensil periphery 125. The one or more utensil handles 120 have the flexible material covering a metal frame making the one or more utensil handles non flexible. For example, the one or more utensil handles 120 are metal reinforced handles with silicone covering. The metal frame can have a circular cross section, a triangular cross section, a rectangular cross section and so forth. The metal reinforcement or metal frame in the handles can be made of different metals. For example, the metal frame can be made of stainless steel. This enables ease of holding the utensils by gripping the handles with hands while allowing flexibility to release food items from the utensil 100. The metal frame is covered by the flexible material such as silicone enabling improved handling and stability of the utensil 100. Moreover, the metal frame covered by the flexible material allows use of the utensil 100 in the microwave as metal is not exposed in the microwave. In an embodiment of the present invention the body periphery 110 has a metal frame such that the body periphery is non flexible. In another embodiment of the present invention the utensil periphery 125 has a metal frame such that the utensil periphery 125 is non flexible.

The utensil 100 with a silicone covered metal reinforced handles improves handling and stability that allows a person to lift the utensil 100, after filing with batter, and take it to a microwave, an oven or a freezer while avoiding spilling. In addition, the utensil 100 with a silicone covered metal frame in the one or more utensil handles 120 is easy to carry as there is no need to carry an additional metal plate or tray (also referred to as cookie sheet or baking tray) under it to provide stability. Further, the utensil 100 with a silicone covered metal frame in the one or more utensil handles 120 allows for use in microwave by ensuring metal is not exposed in the microwave.

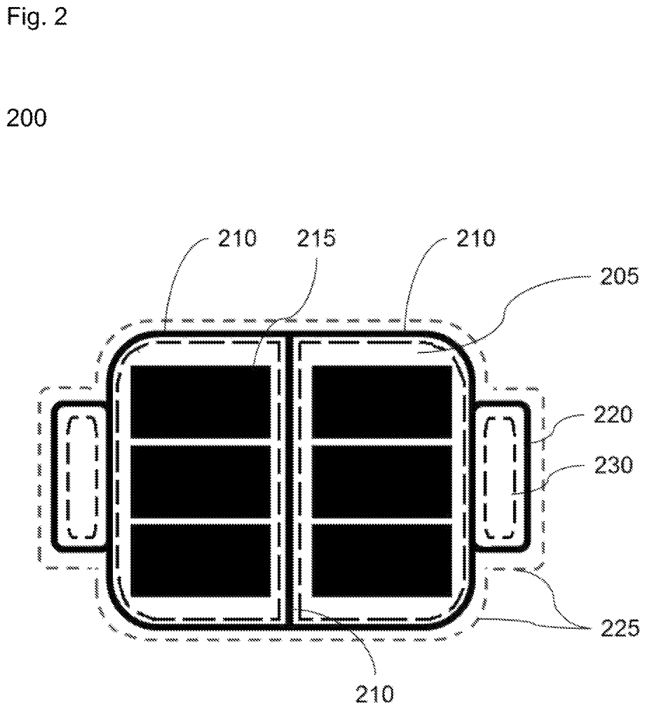

FIG. 2 illustrates a utensil 200, in accordance with another embodiment of the present disclosure. The utensil 200 has a utensil periphery 225. The utensil 200 has a flexible utensil body 205 and a one or more utensil handles 220. The flexible utensil body 205 has a body periphery 210. The body periphery 210 is shown to be at the periphery and at the middle of the flexible utensil body 205 to provide additional strength esp. when the utensil 200 is a large utensil. The flexible utensil body 205 has one or more cavities 215. Handle periphery 230 of the one or more utensil handles 220 and the body periphery 210 together forms the utensil periphery 225. The one or more utensil handles 220 are metal reinforced handles covered with silicone material.

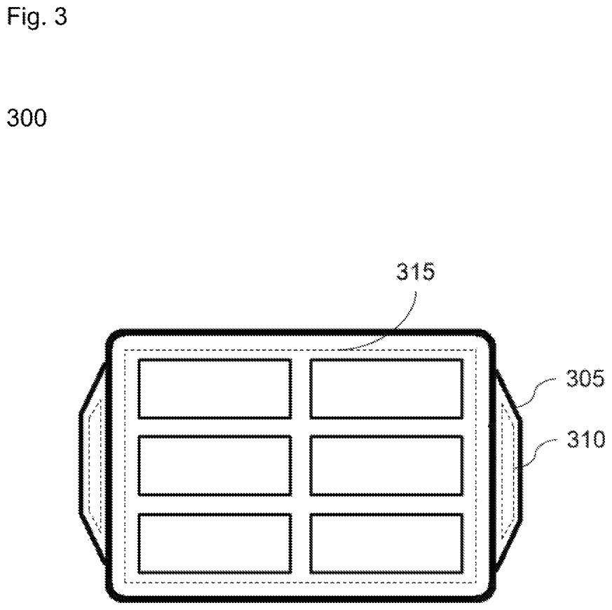

FIG. 3 illustrates a utensil 300, in accordance with yet another embodiment of the present disclosure. The utensil 300 is shown to have metal reinforced handles 305. Metal reinforcement in the handles 305 can be done in various ways including, but not limited to, using a circular cross-section metal rod in the handles, using a rectangular cross-section metal rod in the handles, and so forth. The utensil 300 is shown to include a handle periphery 310 and a body periphery 315. A metal frame or metal reinforcement can be at the combination of the handle periphery 310 and the body periphery 315.

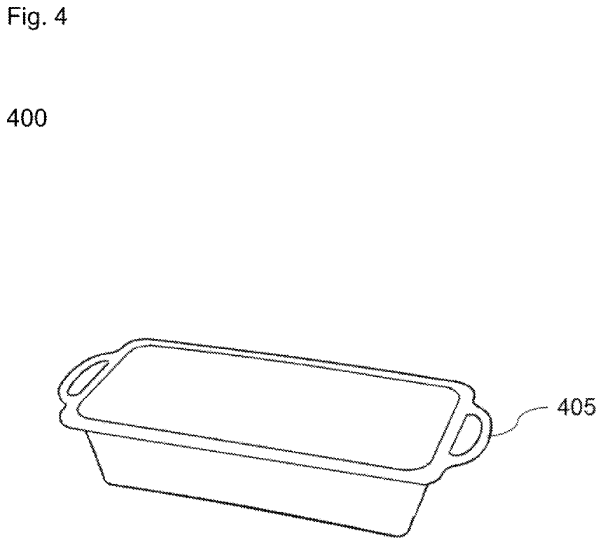

FIG. 4 illustrates a utensil 400, in accordance with another embodiment of the present disclosure. The utensil 400 is shown to have metal reinforced handles 405. For example, handles can be made of a circular cross section metal rod covered by silicone material and rest of the body of the utensil 400 is made of silicone. While flexible silicone body provides for easy release of food from the utensil 400, metal reinforced handle provide stability and strength to the utensil 400, allowing easier handling.

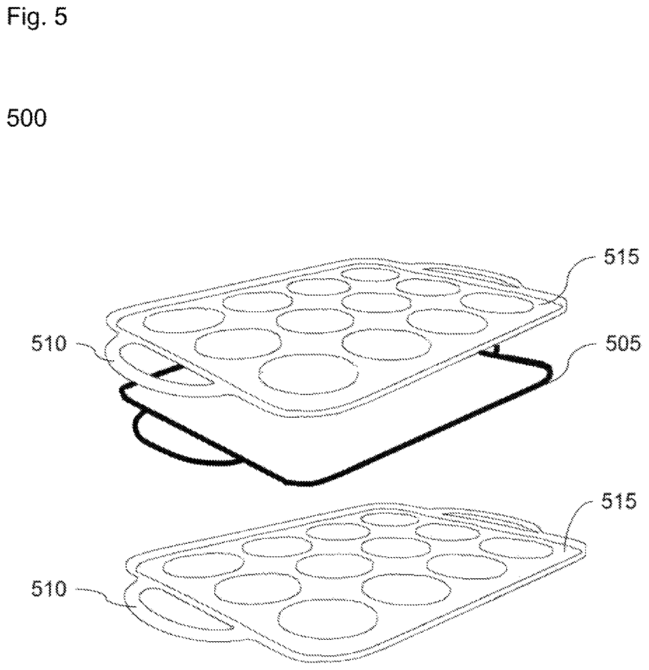

FIG. 5 illustrates a utensil 500, in accordance with another embodiment of the present disclosure. The utensil 500 is shown to include a metal reinforcement (metal frame) 505 along the handles 510 and along the periphery of the utensil 500. Utensil body is shown be to made of a top layer 515 and a bottom layer 515 that sandwiches metal reinforcement 505. The top layer 515 and the bottom layer 515 are made of flexible materials such as silicone, polymer, rubber and so forth.

One or more embodiments of the present disclosure provide a flexible pan with metal reinforced handles providing sturdiness to otherwise the flexible pan. The metal reinforced handles provide stability to the flexible pan and allow carrying the pan without any external support such as a metal tray at the bottom of the pan. One or more embodiments of the present disclosure provide a flexible pan with metal reinforced handles that avoids spills and safety while handling the pan. While most silicone only pans are microwave safe, metal utensils are not used in microwave. One or more embodiments of the present disclosure provide a flexible pan with metal reinforced handles such that the metal reinforced handles are fully covered by the flexible material such as silicone, allowing usage of these flexible pans with metal reinforced handles in microwave as well.

It will be understood to a person ordinarily skilled in the art that a utensil and its handles can be of any shape and sizes, without limiting the scope of the present disclosure. It will be understood to a person ordinarily skilled in the art that the flexible material can be silicone, rubber, polymer, and so forth.

Accordingly, while only a few embodiments of the present invention have been shown and described, it is obvious that many changes and modifications may be made thereunto without departing from the spirit and scope of the invention.

What is claimed is:

1. A utensil defined by a utensil periphery, wherein the utensil comprising:
a. a flexible utensil body, wherein the flexible utensil body is defined by a body periphery, wherein the flexible utensil body is made of a flexible material, wherein the flexible material enables easy release of food from the utensil body; and
b. one or more utensil handles attached to the flexible utensil body, wherein the one or more utensil handles and the body periphery forms the utensil periphery, wherein the one or more utensil handles comprises the flexible material covering a metal frame such that the one or more utensil handles are non flexible, wherein the metal frame is covered by the flexible material, wherein the metal frame enables increased handling and stability of the utensil, wherein the metal frame covered by the flexible material allows use in microwave.

2. The utensil of claim 1, wherein the flexible utensil body has one or more cavities.

3. The utensil of claim 1, wherein the flexible utensil body comprises a top layer and a bottom layer, wherein the top layer and the bottom layer is made of flexible material, wherein the top layer and the bottom layer sandwiches the metal frame and flexible utensil body.

4. The utensil of claim 1, wherein the one or more utensil handles are metal reinforced handles.

5. The utensil of claim 1, wherein the flexible material is silicone.

6. The utensil of claim 1, wherein the body periphery has the metal frame such that the body periphery is non flexible.

7. The utensil of claim 1, wherein the utensil is one of a baking pan and a mold.

8. The utensil of claim 1, wherein the metal frame is made of stainless steel.

9. A utensil defined by a utensil periphery, wherein the utensil comprising:
a. a flexible utensil body, wherein the flexible utensil body is defined by a body periphery, wherein the flexible utensil body has one or more cavities, wherein the flexible utensil body is made of a flexible material, wherein the flexible material enables easy release of food from the utensil body; and
b. one or more utensil handles attached to the flexible utensil body, wherein the one or more utensil handles and the body periphery forms the utensil periphery, wherein the utensil periphery comprises the flexible material covering an metal frame such that the one or more utensil handles are non flexible, wherein the metal frame is covered by the flexible material, wherein the metal frame enables increased handling and stability of the utensil, wherein the metal frame covered by the flexible material allows use in microwave.

10. The utensil of claim 9, wherein the metal frame is a metal rod.

11. The utensil of claim 9, wherein the one or more utensil handles are metal reinforced handles.

12. The utensil of claim 9, wherein the flexible material is silicone.

13. The utensil of claim 9, wherein the body periphery has the metal frame such that the body periphery is non flexible.

14. The utensil of claim 9, wherein the utensil is one of a baking pan and a mold.

15. The utensil of claim 9, wherein the metal frame is made of stainless steel.

16. A utensil defined by a utensil periphery, wherein the utensil comprising:
a. a flexible utensil body, wherein the flexible utensil body is defined by a body periphery, wherein the flexible utensil body has one or more cavities, wherein the flexible utensil body is made of a flexible material, wherein the flexible material enables easy release of food from the utensil body, wherein the body periphery has the metal frame such that the body periphery is non flexible; and
b. one or more utensil handles attached to the flexible utensil body, wherein the one or more utensil handles and the body periphery forms the utensil periphery, wherein the one or more utensil handles comprises the flexible material covering an metal frame such that the one or more utensil handles are non flexible, wherein the metal frame is covered by the flexible material, wherein the metal frame enables increased handling and stability of the utensil, wherein the metal frame covered by the flexible material allows use in microwave.

17. The utensil of claim 16, wherein the flexible material is silicone.

18. The utensil of claim 16, wherein the metal frame is made of stainless steel.

19. The utensil of claim 16, wherein the metal frame is a metal rod.

20. The utensil of claim 16, wherein the one or more utensil handles are metal reinforced handles.
